(19) United States
(12) Patent Application Publication
(10) Pub. No.: US 2008/0127762 A1
(43) Pub. Date: Jun. 5, 2008

(54) Composite Steering Rack

(75) Inventor: John Baxter, New South Wales (AU)

Correspondence Address: BIRCH STEWART KOLASCH & BIRCH, PO BOX 747, FALLS CHURCH, VA, 22040-0747, US

(73) Assignee: BISHOP INNOVATION LIMITED, North Ryde, NSW (AU)

(21) Appl. No.: 11/667,785

(22) PCT Filed: Dec. 13, 2005
(86) PCT No.: PCT/AU2005/001878

§ 371 Date: May 15, 2007

(30) Foreign Application Priority Data
Dec. 20, 2004 (AU) 2004907203

(51) Int. Cl. B62D 3/12; F16H 19/04

(52) U.S. Cl. 74/422

(57) ABSTRACT

A steering rack for a vehicle rack and pinion steering gear comprising a first member having a toothed region, attached to a tubular second member. The second member having a region of increased wall thickness and reduced bore diameter formed by an upsetting operation. The region of increased wall thickness being located at or near the end of the second member that is attached to the first member.

### TECHNICAL FIELD

The present invention relates to steering racks for vehicle rack and pinion steering gears, and more particularly to such racks manufactured by attaching a tubular member to a toothed member.

### BACKGROUND

Most vehicle steering racks are manufactured from round solid bar stock, with the toothed region broached across the bar near one end. This results in the cross section of the toothed region having a ‘D’ shape and hence these racks are commonly referred to as “D-racks”. The toothed region of such a broached D-rack has significantly less bending strength than the round solid shank extending from it. However, to minimise the weight of the steering rack, it is desirable that the toothed region and the shank have similar bending strength. A common approach to this problem is to gun drill the shank over most of its length resulting in a substantially tubular shank. However, the disadvantages of gun drilling are that material is wasted and it is a relatively expensive process.

An alternative method of manufacturing a steering rack from round solid bar stock is to forge the toothed region. U.S. Pat. Nos. 4,571,982 (Bishop) and 5,862,701 (Bishop et al) disclose die apparatus for flashless warm forging the toothed region to net shape. “Net shape” means that the forged rack teeth do not require any further machining after forging. An advantage of forging is that the rack teeth may be shaped to have a variable gear ratio. The cross section of the toothed region of racks forged by this type of die has a ‘Y’ shape and such racks are commonly referred to as “Y-racks”. The toothed region of a forged Y-rack has greater bending strength than the toothed region of a D-rack broached from the same diameter solid bar, and so Y-racks can be forged from smaller diameter bar whilst maintaining overall bending strength. However, the shanks of Y-racks are still commonly gun drilled to further reduce weight. It is also possible to forge the toothed region of a D-rack and WO 2005/053875 (Bishop Innovation Limited) discloses a die apparatus for flashless warm forging D-racks.

Numerous attempts have been made to further reduce weight by the manufacture of hollow steering racks from tube stock. One such method used in limited production is disclosed in U.S. Pat. No. 4,598,451 (Takanosuke) where a series of mandrels is passed through a flattened tube to progressively fill an external tooth die. This method is relatively expensive and time consuming and as such is not well suited to high volume production. Furthermore, the size of teeth that can be produced is limited by the wall thickness of the tube and the method is not well suited to producing racks with variable ratio teeth.

A “composite rack” is defined as a rack made by joining two or more members to each other. Typically a composite rack is made by joining a shank made from tube to a short solid rack member. Such composite racks have the advantages of reduced weight without the limitations of forming the rack teeth onto a tube. Various methods of making composite racks have been proposed or used in limited production. For example, a composite steering rack has been used in Honda “Odyssey” vehicles. This rack is made by welding a tubular shank to a short solid forged D-rack. The wall thickness of the tube used to form the shank of such racks is typically constant and as such must be thick enough to accommodate the features of the shank, such as threads and grooves, without locally weakening the rack. One end of the shank typically has an internal thread to attach a tie rod to the end of the rack. In the case of steering racks for hydraulic power steering gears, the shank may have one or more external circumferential grooves approximately mid way along the shank for locating a hydraulic piston. The end of the tubular shank that is attached to the rack member must also be thick enough to form a strong joint. As a result of accommodating these features on a tubular shank of constant wall thickness, the remainder of the tubular shank is thicker than it needs to be and as such these composite racks do not fully exploit the weight saving potential of having a tubular shank.

The present invention seeks to provide a composite steering rack that ameliorates at least some of the disadvantages of the prior art.

### SUMMARY OF INVENTION

The present invention consists of a steering rack for a vehicle rack and pinion steering gear, comprising a first member having a toothed region, attached to a tubular second member, wherein said second member has a region of increased wall thickness and reduced bore diameter formed by an upsetting operation, said region of increased wall thickness being located at or near the end of said second member that is attached to said first member.

In a first preferred embodiment, said first member is attached to said second member by threaded fastening.

Preferably, said threaded fastening comprises a male thread at one end of said first member engaging a female thread formed in said region of increased wall thickness of said second member.

Preferably, said first member has a radial step, disposed between said toothed region and said male thread, and the end of said second member that is attached to said first member abuts against said step.

Preferably, said threaded fastening is secured by locally deforming said second member into a recess in said first member.

Preferably, said recess comprises a hole and said local deformation comprises staking the wall of said second member into said hole.

Preferably, said first member has a cylindrical locating portion that is a location fit in the bore of said second member.

Preferably, said threaded fastening is secured by a thread locking adhesive.

In a second preferred embodiment, said first and second members are attached to each other by a welding operation.

Preferably, the end of said first member that is welded to said second member has a tubular portion having inside and outside diameters substantially equal to that of said region of increased wall thickness.

Preferably, said region of increased wall thickness and the portions of said second member immediately adjacent thereto have substantially the same outside diameter.

Preferably, said first member is substantially solid.

Preferably, said upsetting operation is performed prior to attaching said first and second members to each other.

Preferably, said toothed region is flashless warm forged.

### BRIEF DESCRIPTION OF DRAWINGS

FIG. 1 shows a first embodiment of a composite steering rack in accordance with the present invention.

FIG. 2 is a cross sectional view through II-II of the steering rack of FIG. 1.

FIG. 3 is a detail perspective view of the members of the steering rack of FIG. 1 showing the attachment end of each member prior to assembly.

FIG. 4 is a detail sectional view of the attachment region of the steering rack of FIG. 1.

FIG. 5 shows a detail sectional view of a second embodiment of a composite rack in accordance with the present invention.

FIG. 6 is a detail perspective view of the members of the steering rack of FIG. 5 showing the attachment end of each member prior to assembly.

FIG. 7 shows a third embodiment of a composite steering rack in accordance with the present invention.

FIG. 8 is a cross sectional view through VIII-VIII of the steering rack of FIG. 7.

FIG. 9 is a detail perspective view of the members of the steering rack of FIG. 7 showing the attachment end of each member prior to assembly.

FIG. 10 is a detail sectional view of the attachment region of the steering rack of FIG. 7.

### BEST MODE OF CARRYING OUT THE INVENTION

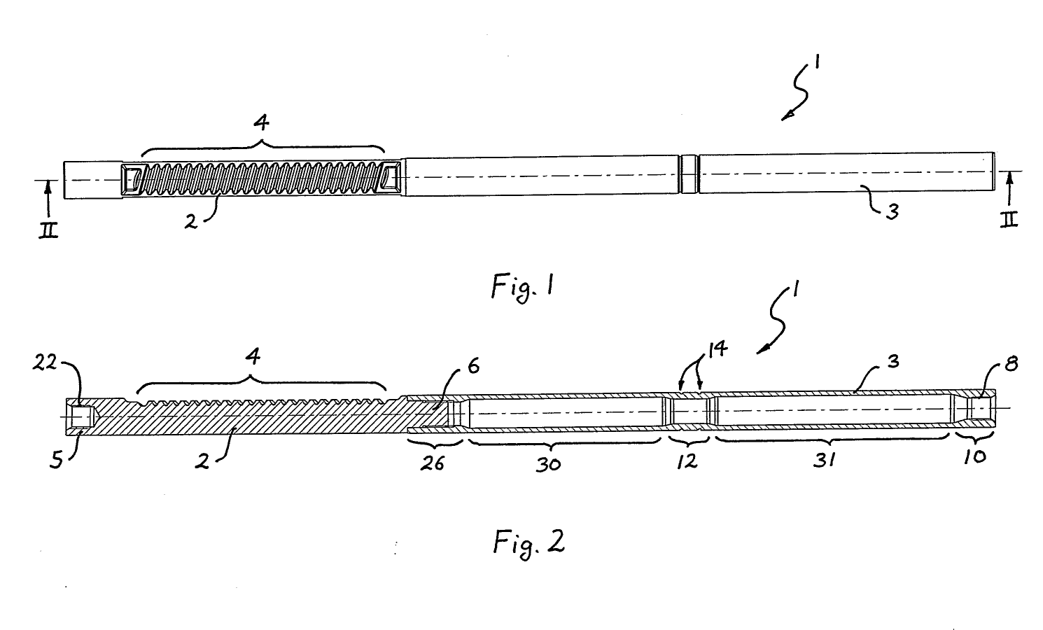

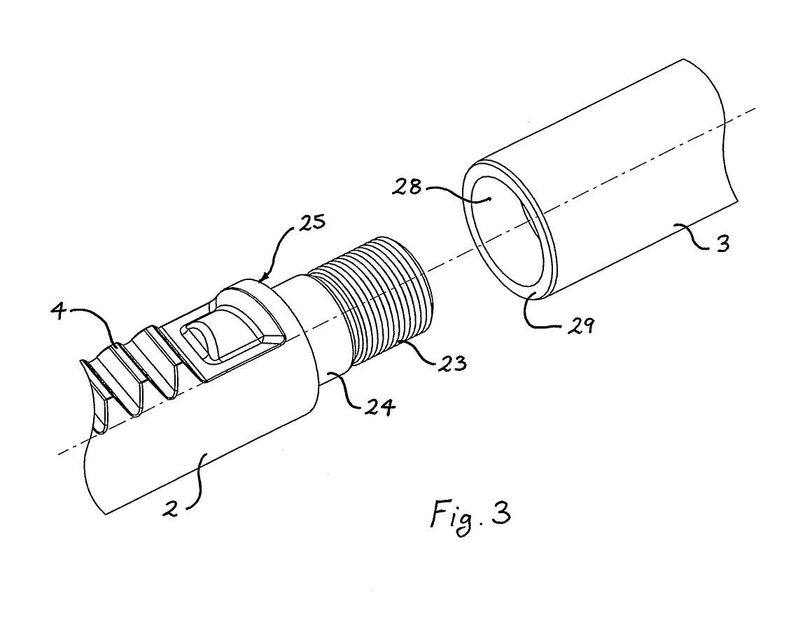

FIGS. 1 to 4 depict a first embodiment of a composite steering rack 1 in accordance with the present invention comprising a forged D-rack toothed member 2 and a tubular shank member 3. Toothed member 2 has a toothed region 4 over a substantial length thereof, a tie rod end 5, with an internal thread 22 for attaching a tie rod, and an attachment end 6 at the opposite end thereof.

Toothed member 2 may be flashless warm forged from a solid cylindrical blank using a die apparatus such as disclosed in WO 2005/053875 (Bishop Innovation Limited). Once toothed member 2 has been forged, toothed region 4 is subsequently induction hardened. The ends of toothed member 2 are left soft to allow for machining to form tie rod end 5 and attachment end 6. Attachment end 6 comprises a male thread 23, a cylindrical locating portion 24, and a radial step 25 axially located between male thread 23 and toothed region 4. Cylindrical locating portion 24 is axially located between radial step 25 and male thread 23.

Tubular shank member 3 is manufactured from a length of tube (not shown) of constant diameter and wall thickness. Tubular shank member 3 has the same constant wall thickness and outside diameter as the original tube along its length except for regions 10, 12 and 26, which have increased wall thickness and reduced bore diameter formed by localised upsetting operations. The outside diameter of regions 10, 12 and 26 is the same as the original tube. Regions 30 and 31 of tubular member 3 have the same constant wall thickness and outside diameter as the original tube. The upsetting operation may be performed by locally heating the tube and then axially compressing it whilst restraining the outside diameter of the tube by rollers or the like. By restraining the outside diameter, the tube is upset inwardly thereby increasing the wall thickness and reducing the bore diameter.

Thickened region 12 has two circumferential grooves 14 machined on its outside diameter to locate a hydraulic piston (not shown). Since circumferential grooves 14 are in a region of increased wall thickness they do not weaken tubular shank member 3. Thickened region 10 is at the end of tubular shank member 3 that forms one end of rack 1 and has an internal thread 8 machined therein for attaching a tie rod end.

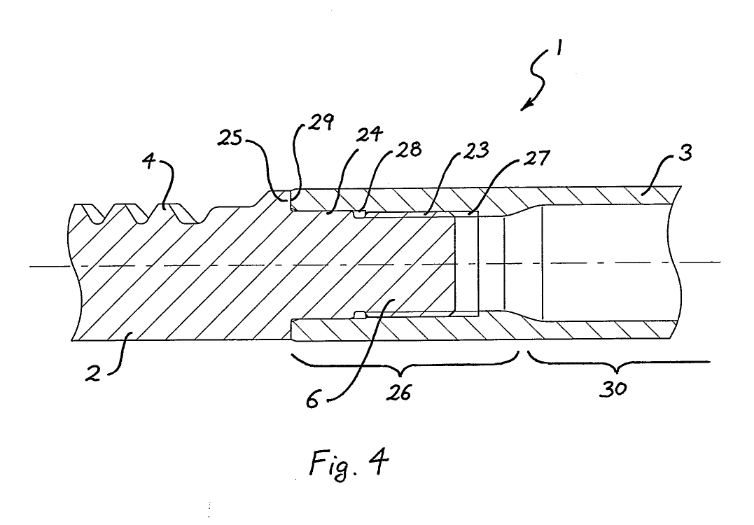

Referring to FIG. 4, thickened region 26 is at the end of tubular member 3 that is attached to toothed member 2. Female thread 27 and locating hole 28 are machined in the bore of thickened region 26. Toothed member 2 and tubular member 3 are attached to each other by male thread 23 engaging female thread 27 until the end face 29 of tubular member 3 abuts against the radial step 25 on toothed member 2. Preferably the threaded joint is tightened to an extent that no portion of end face 29 ever separates from radial step 25 during loads applied to rack 1 in service. By preloading the thread in this manner, the stiffness of the attachment region of rack 1 is not reduced, in comparison to the adjacent portions of rack 1, by the reduction in diameter of the end 6 of toothed member 2 that is necessary to form male thread 23. The threaded joint may be secured by using a thread locking adhesive. Cylindrical locating portion 24 is a location fit inside locating hole 28 to provide accurate alignment of toothed member 2 with tubular member 3.

The localised thickening of tubular member 3 at regions 10, 12 and 26, provided by the upsetting operation, clearly allows tubular shank member 3 to be manufactured from a thinner wall tube than would otherwise be required if tubular shank member 3 was of constant wall thickness. To minimise the weight of rack 1 whilst maintaining strength at all points along tubular member 3, the attachment end of tubular member 3, having thickened region 26, must be thicker than its adjacent purely cylindrical region 30 to provide sufficient wall thickness to machine female thread 27 and locating hole 28. Furthermore, the attachment end must have a thicker wall to provide sufficient strength for the threaded joint to be preloaded as described above. Similarly, thickened regions 10 and 12 allow their features to be machined onto them without locally weakening tubular member 3.

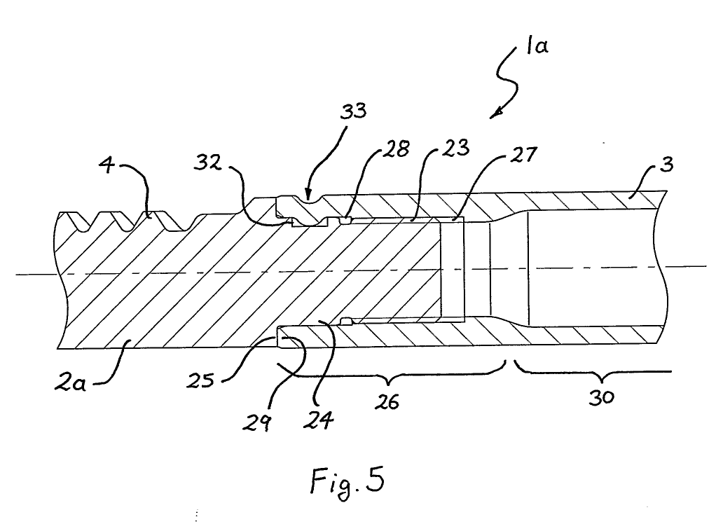

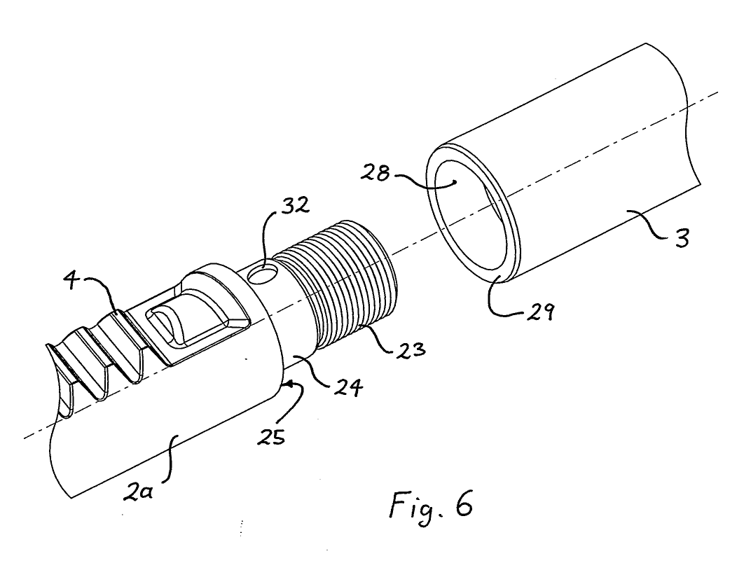

FIGS. 5 and 6 depict a second embodiment of a composite steering rack 1a in accordance with the present invention. Rack 1a is the same as rack 1 depicted in FIGS. 1 to 4 except that tubular member 3 is staked to toothed member 2a after assembly to secure the threaded joint against loosening when rack 1a is in service. Toothed member 2a has a shallow hole 32 formed on the periphery of cylindrical locating portion 24. After the threaded joint has been tightened, the wall of tubular member 3 is staked into hole 32 using a suitable tool to form a local indent 33. Other local deformation methods that key the toothed member and tubular member against relative rotation may also be used to secure the threaded joint. For example, hole 32 may be replaced by a longitudinal groove, such as a keyway, or multiple holes may be used instead of just one.

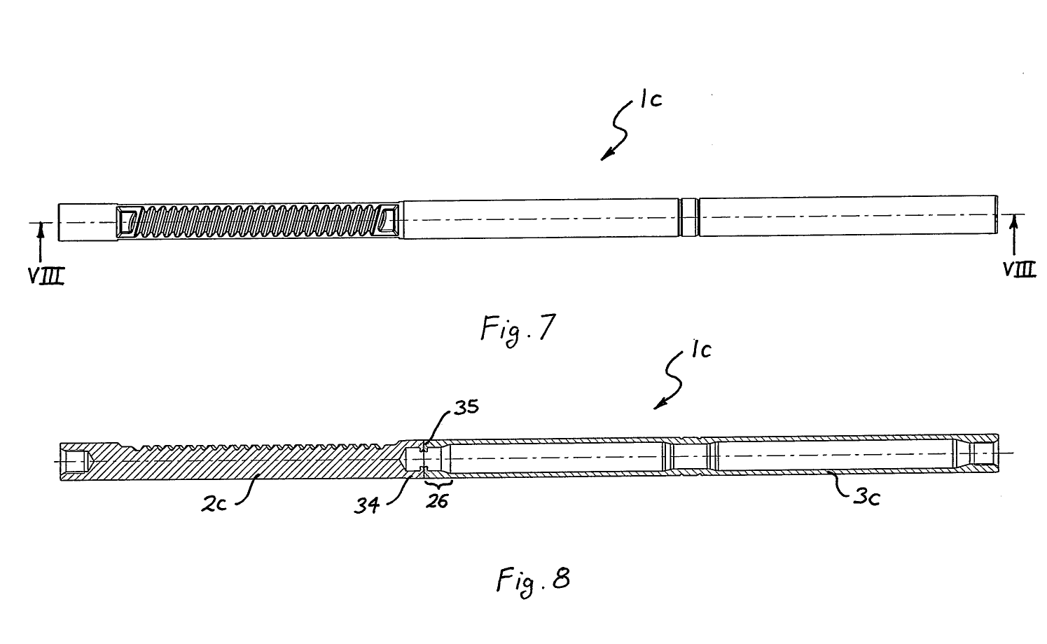

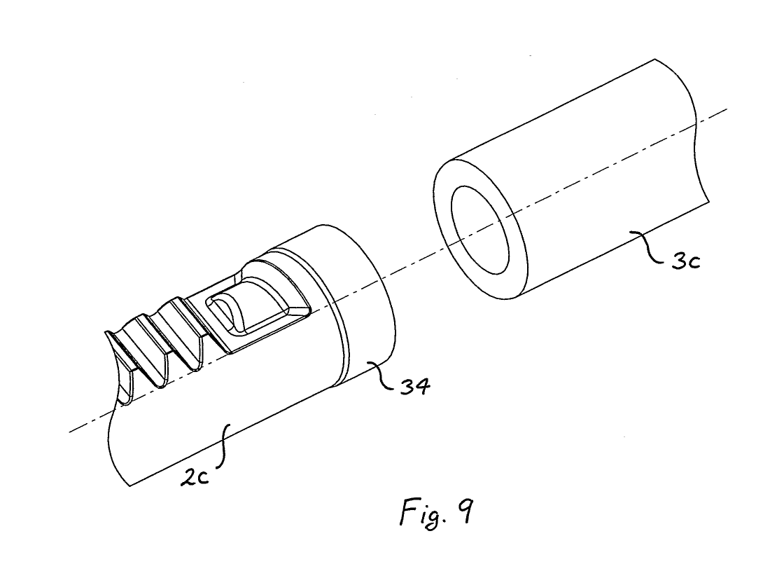

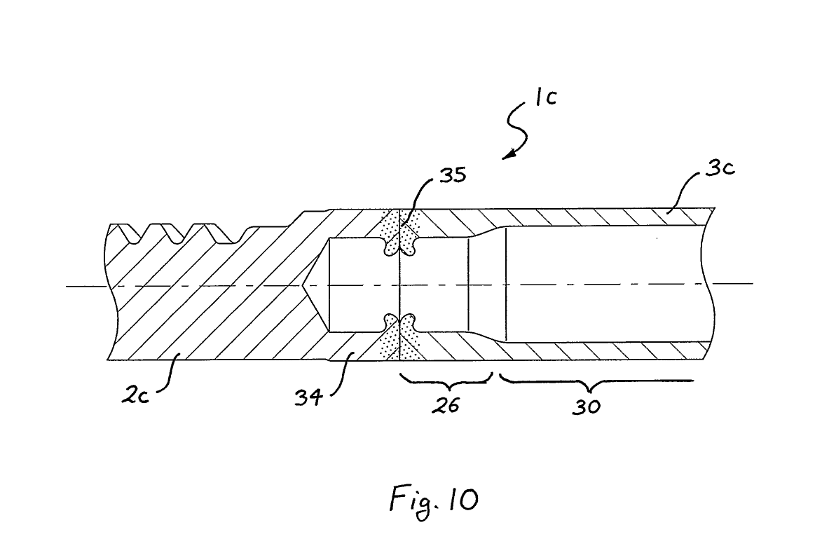

FIGS. 7 to 10 depict a third embodiment of a composite steering rack 1c in accordance with the present invention. Rack 1c is similar to rack 1 depicted in FIGS. 1 to 4 except that toothed member 2c is attached to tubular member 3c by a welding operation, instead of threaded fastening. The attachment end of toothed member 2c is machined to form a short axially extending tubular portion 34 having substantially the same inside and outside diameters as the thickened wall region 26 at the attachment end of tubular member 3c. The welding operation is preferably performed using a magnetic arc, friction or laser welding process, and results in a welded joint 35. Once welding has taken place, any external excess weld seam may be removed in a conventional manner. A tempering and stress relieving operation may also be carried out on the weld. After welding, tubular shank member 3c may be induction hardened and ground to finished size. The advantage of region 26 having an increased wall thickness, compared to the adjacent portion 30 of tubular member 3c, is that the strength of the welded joint 35 is increased without significantly increasing the overall weight of the rack.

Whilst the embodiment described above utilises a ‘D’ shaped tooth member, it should be understood that tooth members of other forms may be used, such as ‘Y’ shaped tooth members. It should also be understood that the tooth member may be made by a machining operation, such as broaching, instead of forging. Furthermore, the teeth of the toothed member may have either a constant ratio or variable ratio form.

The term “comprising” as used herein is used in the inclusive sense of “including” or “having” and not in the exclusive sense of “consisting only of”.

1. A steering rack for a vehicle rack and pinion steering gear, comprising a first member having a toothed region, attached to a tubular second member, wherein said second member has a region of increased wall thickness and reduced bore diameter formed by an upsetting operation, said region of increased wall thickness being located at or near the end of said second member that is attached to said first member.

2. A steering rack as claimed in claim 1, wherein said first member is attached to said second member by threaded fastening.

3. A steering rack as claimed in claim 2, wherein said threaded fastening comprises a male thread at one end of said first member engaging a female thread formed in said region of increased wall thickness of said second member.

4. A steering rack as claimed in claim 3, wherein said first member has a radial step, disposed between said toothed region and said male thread, and the end of said second member that is attached to said first member abuts against said step.

5. A steering rack as claimed in claim 2, wherein said threaded fastening is secured by locally deforming said second member into a recess in said first member.

6. A steering rack as claimed in claim 5, wherein said recess comprises a hole and said local deformation comprises staking the wall of said second member into said hole.

7. A steering rack as claimed in claim 2, wherein said first member has a cylindrical locating portion that is a location fit in the bore of said second member.

8. A steering rack as claimed in claim 2, wherein said threaded fastening is secured by a thread locking adhesive.

9. A steering rack as claimed in claim 1, wherein said first and second members are attached to each other by a welding operation.

10. A steering rack as claimed in claim 9, wherein the end of said first member that is welded to said second member has a tubular portion having inside and outside diameters substantially equal to that of said region of increased wall thickness.

11. A steering rack as claimed in claim 1, wherein said region of increased wall thickness and the portions of said second member immediately adjacent thereto have substantially the same outside diameter.

12. A steering rack as claimed in claim 1, wherein said first member is substantially solid.

13. A steering rack as claimed in claim 1, wherein said upsetting operation is performed prior to attaching said first and second members to each other.

14. A steering rack as claimed in claim 1, wherein said toothed region is flashless warm forged.
